(19) United States
(12) Patent Application Publication
(10) Pub. No.: US 2015/0145176 A1
(43) Pub. Date: May 28, 2015

(54) METHOD FOR MANUFACTURING REFLECTIVE FILM AND APPARATUS FOR MANUFACTURING THE SAME

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); KUN-CHAN WU, Tu-Cheng (TW); JIA-MING WANG, New Taipei (TW)

(73) Assignee: HON HAI PRECISION INDUSTRY CO., LTD., New Taipei (TW)

(21) Appl. No.: 14/102,519

(22) Filed: Dec. 11, 2013

(30) Foreign Application Priority Data
Nov. 27, 2013 (TW) 102143342

(51) Int. Cl. B29D 11/00; B29C 71/04; B29C 41/28

(52) U.S. Cl. CPC B29D 11/00788; B29C 41/28; B29C 71/04
USPC 264/495; 425/174.4

(57) ABSTRACT

A method for manufacturing a reflective film is disclosed. A nozzle is used to spray a mixture of photosensitive adhesive and white powder on a conveyor belt. A first roller and a second roller are used to press the mixture transferred by the conveyor belt. A first light source and a second light source are used to illuminate the mixture to form the reflective film. The reflective film is further pressed by a third roller and then coiled by a rolling device. An apparatus for manufacturing the reflective film is also disclosed.

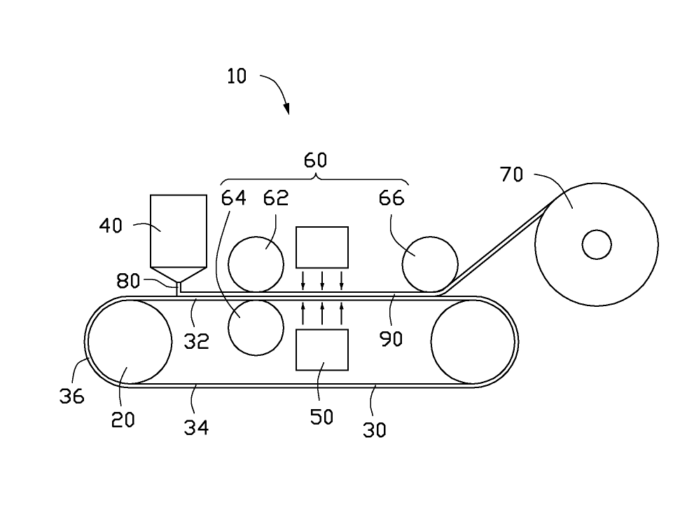

### BACKGROUND

1. Technical Field

The disclosure generally relates to methods for manufacturing reflective films and apparatuses for manufacturing the reflective films, and more particularly, to a low-cost method for manufacturing a reflective film and a low-cost apparatus for manufacturing the reflective film.

2. Description of Related Art

A reflective film is usually used in the backlight module for increasing brightness of the display. A typical reflective film is made of plastic mixed with white powder. The plastic and the white powder are firstly mixed with each other, and then heated and pressed to form a primary film. The primary film is further stretched to reduce the thickness thereof, thereby forming the reflective film. The reflective film is finally rolled for transportation.

However, the pressing and stretching apparatuses used in the manufacturing process of the reflective film are expensive. Thus, the cost of the reflective film manufactured by the apparatuses is also high.

What is needed, therefore, is a method for manufacturing a reflective film and an apparatus for manufacturing the reflective film which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

The only FIGURE shows an apparatus for manufacturing a reflective film in accordance with an embodiment of the present disclosure.

### DETAILED DESCRIPTION

Referring to the only FIGURE, an apparatus 10 for manufacturing a reflective film 90 is shown. The apparatus 10 includes a conveyor belt 30, a nozzle 40, a roller group 60, two light sources 50 and a rolling device 70.

The nozzle 40 is located above the conveyor belt 30. The nozzle 40 is used to spray a mixture 80 of a photosensitive adhesive and white powder on the conveyor belt 30.

The conveyor belt 30 is spaced from the nozzle 40 to allow the mixture 80 falling on a surface thereof. The conveyor belt 30 may be made of transparent material such as polydimethylsiloxane. The conveyor belt 30 is driven by two wheels 20 to circulate, thereby transferring the mixture 80 to different locations. The conveyor belt 30 has a first belt 32, a second belt 34 and two third belts 36 interconnecting the top belt 32 and the bottom belt 34. The first belt 32 supports the mixture 80 on a top face thereof. A moving velocity of the conveyor belt 30 is equal to a spraying velocity of the nozzle 40 so that the mixture 80 can be continuously and uniformly distributed on the top face of the first belt 32.

The roller group 60 includes a first roller 62 and a second roller 64 adjacent to the nozzle 40, and a third roller 66 away from the nozzle 40. The first roller 62 is located above the first belt 32, the second roller 64 is located below the first belt 32 and opposite to the first roller 62. The first roller 62 is spaced a gap from the top face of the first belt 32, and the second roller 64 directly presses against a bottom face of the first belt 32. A distance between the first roller 62 and the top face of the first belt 32 is less than a thickness of the mixture 80 distributed on the first belt 32. Thus, when the mixture 80 is transported by the first belt 32 to pass through the gap between the first roller 62 and the first belt 32, the mixture 80 is pressed by the first roller 62 and the second roller 64 to become thinner.

The two light sources 50 are located adjacent to the first roller 62 and the second roller 64. The two light sources 50 include a first light source 50 located above the first belt 32 and a second light source 50 located below the first belt 32. The first light source 50 and the second light source 50 are opposite to each other. In this embodiment, the first light source 50 and the second light source 50 are ultraviolet light sources, and the photosensitive adhesive is an ultraviolet curable adhesive. Light emitted from the first light source 50 directly illuminate a top face of the mixture 80 transferred by the first belt 32, light emitted from the second light source 50 passes through the first belt 32 to illuminate a bottom face of the mixture 80. Therefore, since both the top face and the bottom face are illuminated, the photosensitive adhesive can be cured rapidly and sufficiently. The cured photosensitive adhesive has the white powder doped therein, thereby forming a reflective film 90. The light emitted from the second light source 50 has a part losing when passing through first belt 32. Thus, the intensity of the light illuminating the top face of the mixture 80 is different from that illuminating the bottom face of the mixture 80, resulting in different curing speed between the top face and the bottom face of the mixture 80. In order to achieve the same curing speed of the top face and the bottom face of the mixture 80, the light intensity of the second light source 50 should be larger than that of the first light source 50.

The third roller 66 is located adjacent one of the two wheels 20. The third roller 66 is located above the first belt 32. A distance between the third roller 66 and the top face of the first belt 32 is less than a thickness of the reflective film 90. Thus, when the reflective film 90 is transferred by the conveyor belt 30 to pass through the third roller 66, the reflective film 90 is further pressed by the third roller 66 to become much thinner. A distance between the third roller 66 and the first light source 50 is larger than that between the first roller 62 and the first light source 50.

The rolling device 70 is located adjacent to the third roller 66. The rolling device 70 rolls the reflective film 90 on a circumferential face thereof for facilitating transportation of the reflective film 90. Preferably, the reflective film 90 is pulled upwardly and inclinedly by the rolling device 70 at a position below the third roller 66. That is to say, as soon as the reflective film 90 is pressed by the third roller 66, the reflective film 90 is rolled by the rolling device 70.

The roller group 60 and the two light sources 50 used in the manufacturing process have low cost, whereby a cost of the reflective film 90 is reduced accordingly. Furthermore, the photosensitive adhesive has a short curing time, whereby the manufacturing process of the reflective film 90 is fast. In addition, the photosensitive adhesive has a low coefficient of elasticity, whereby the reflective film 90 can be pressed much thinner. More white powder can also be doped within the photosensitive adhesive, whereby the reflective film 90 can have a high reflective efficiency.

A method for manufacturing the reflective film 90 is also disclosed. Firstly, the nozzle 40 is used to spray the mixture 80 on the first belt 32 of the conveyor belt 30. The conveyor belt 30 transfers the mixture 80 to pass through the first roller 62 and the second roller 64. The mixture 80 is pressed by the first roller 62 and the second roller 64 to become thinner. The pressed mixture 80 is further transferred by the conveyor belt 30 to pass through the two light sources 50, which illuminate the mixture 80 to make the mixture 80 curing. The cured mixture 80 forms the reflective film 90 and transferred by the conveyor belt 30 to pass through the third roller, which further presses the reflective film 90 to make the reflective film 90 much thinner. Finally, the further pressed reflective film 90 is rolled by the rolling device 70.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for manufacturing a reflective film, comprising:
using a nozzle to spray a mixture of photosensitive adhesive and white powder on a conveyor belt;
using a first roller to press the mixture transferred by the conveyor belt;
using a first light source to illuminate the mixture such that the mixture is cured to form the reflective film; and
using a rolling device to coil the reflective film.

2. The method of claim 1, wherein a second roller is used with the first roller to press the mixture transferred by the conveyor belt.

3. The method of claim 2, wherein the first roller is located above the conveyor belt, and the second roller is located below the conveyor belt.

4. The method of claim 3, wherein the first roller is spaced from the conveyor belt, and the second roller directly contacts the conveyor belt.

5. The method of claim 1, wherein the conveyor belt is made of transparent material.

6. The method of claim 5, wherein a second light source is used with the first light source to illuminate the mixture.

7. The method of claim 6, wherein the first light source is located above the conveyor belt, and the second light source is located below the conveyor belt.

8. The method of claim 7, wherein a light intensity of the second light source is higher that that of the first light source.

9. The method of claim 2, wherein a third roller is used to press the reflective film before the reflective film is coiled by the rolling device.

10. The method of claim 9, wherein the first light source is located between the first roller and the third roller.

11. The method of claim 9, wherein the third roller is located above the conveyor belt.

12. An apparatus for manufacturing a reflective film, comprising:
a nozzle spraying a mixture of photosensitive adhesive and white powder;
a conveyor belt transferring the mixture;
a first roller pressing the mixture transferred by the conveyor belt;
a first light source illuminating the mixture pressed by the first roller so that the mixture is cured to form the reflective film; and
a rolling device coiling the reflective film.

13. The apparatus of claim 12, wherein the conveyor belt is made of transparent material.

14. The apparatus of claim 13 further comprising a second light source illuminating the mixture, wherein the first light source is located above the conveyor belt, and the second light source is located below the conveyor belt.

15. The apparatus of claim 14, wherein the second light source has a light intensity larger than that of the first light source.

16. The apparatus of claim 12 further comprising a second roller pressing the mixture, wherein the first roller is located above the conveyor belt, and the second roller is located below the conveyor belt.

17. The apparatus of claim 16 further comprising a third roller pressing the reflective film, wherein the first light source is located between the first roller and the third roller.
